(19) United States
(12) Patent Application Publication
(10) Pub. No.: US 2024/0337399 A1
(43) Pub. Date: Oct. 10, 2024

(54) FAILURE DIAGNOSIS APPARATUS, FAILURE DIAGNOSIS METHOD, AND NON-TRANSITORY COMPUTER READABLE MEDIUM

(71) Applicant: Mitsubishi Electric Corporation, Tokyo (JP)

(72) Inventor: Nobuyuki MIYAKE, Tokyo (JP)

(73) Assignee: Mitsubishi Electric Corporation, Tokyo (JP)

(21) Appl. No.: 18/746,355

(22) Filed: Jun. 18, 2024

Related U.S. Application Data
(63) Continuation of application No. PCT/JP2022/004502, filed on Feb. 4, 2022.

(51) Int. Cl. F24F 11/38; F24F 11/64

(52) U.S. Cl. CPC F24F 11/38; F24F 11/64

(57) ABSTRACT

A failure diagnosis apparatus (100) calibrates an air conditioner model (191) by adjusting a value of a parameter of the air conditioner model (191) used when a simulation of operation of an air conditioner (200) is executed, and also includes a parameter selection unit (130). The parameter selection unit (130) selects from among parameters of the air conditioner model (191), each parameter that forms an adjustment parameter group that consists of at least one parameter whose value is a candidate to be adjusted when the air conditioner model (191) is calibrated based on a condition according to a state of the air conditioner (200).

### CROSS REFERENCE TO RELATED APPLICATION

This application is a Continuation of PCT International Application No. PCT/JP2022/004502, filed on Feb. 4, 2022, which is hereby expressly incorporated by reference into the present application.

### TECHNICAL FIELD

The present disclosure relates to a failure diagnosis apparatus, a failure diagnosis method, and a failure diagnosis program.

### BACKGROUND ART

In order for a maintenance worker to specify a failure cause of an air conditioner, it is preferable that the maintenance worker have a high technical skill. However, there is a case where a new maintenance worker or the like specifies the failure cause due to a labor shortage or the like. Further, especially in an emerging country or the like, there is often a problem with a technical skill of a maintenance worker due to a reason such that the maintenance worker does not stay for a long term. Thus, a technique is used in which specification of a failure cause, selection of a part, or the like is automatically executed using operation data or the like of the air conditioner.

The operation data of the air conditioner used to specify the failure cause depends on customer environment factors. Here, specific examples of the customer environment factors are factors such as a length of a pipe connected to an outdoor unit, a size of a room in which the air conditioner is installed, an outdoor air temperature, and the like. Therefore, a method set in advance as a method to specify the failure cause may not function appropriately. Accordingly, it is necessary to calibrate an air conditioner model according to the customer environment factors.

Patent Literature 1 discloses a technique to update a control subject model according to an error between a control subject apparatus and the control subject model.

### CITATION LIST

### Patent Literature

Patent Literature 1: pamphlet of WO 2014/155596 A1

### SUMMARY OF INVENTION

### Technical Problem

Patent Literature 1 discloses a technique to reduce the number of parameters to be identified by adjusting among parameters of the control subject model, only a variable parameter indicating an amount by which its value may change during operation of the control subject apparatus. However, when the air conditioner model is calibrated using the technique disclosed in Patent Literature 1, there is a problem that the calibration of the air conditioner model requires a massive time since the air conditioner model has the large number of parameters.

The present disclosure aims to shorten the time required for the calibration of the air conditioner model.

### Solution to Problem

A failure diagnosis apparatus according to the present disclosure that calibrates an air conditioner model by adjusting a value of a parameter of the air conditioner model used when a simulation of operation of an air conditioner is executed, the failure diagnosis apparatus includes a parameter selection unit to select from among parameters of the air conditioner model, each parameter that forms an adjustment parameter group that consists of at least one parameter whose value is a candidate to be adjusted when the air conditioner model is calibrated based on a condition according to a state of the air conditioner.

### Advantageous Effects of Invention

According to the present disclosure, a parameter selection unit selects from among parameters of an air conditioner model, at least one parameter whose value is a candidate to be adjusted when the air conditioner model is calibrated based on a condition according to a state of an air conditioner. Accordingly, according to the present disclosure, the number of calibration subject parameters of the air conditioner model can be reduced and a time required for the calibration can be shortened.

### BRIEF DESCRIPTION OF DRAWINGS

FIG. 1 is a diagram illustrating a configuration example of a failure diagnosis system 90 according to Embodiment 1.

FIG. 2 is a diagram for explaining a parameter definition DB 193 according to Embodiment 1.

FIG. 3 is a diagram for explaining an outline of the failure diagnosis system 90 according to Embodiment 1.

FIG. 4 is a diagram illustrating a hardware configuration example of a failure diagnosis apparatus 100 according to Embodiment 1.

FIG. 5 is a diagram for explaining processing of the failure diagnosis apparatus 100 according to Embodiment 1.

FIG. 6 is a diagram for explaining the processing of the failure diagnosis apparatus 100 according to Embodiment 1.

FIG. 7 is a flowchart illustrating operation of the failure diagnosis apparatus 100 according to Embodiment 1.

FIG. 8 is a diagram for explaining the processing of the failure diagnosis apparatus 100 according to Embodiment 1.

FIG. 9 is a flowchart illustrating the operation of the failure diagnosis apparatus 100 according to Embodiment 1.

FIG. 10 is a diagram for explaining the processing of the failure diagnosis apparatus 100 according to Embodiment 1.

FIG. 11 is a diagram for explaining the processing of the failure diagnosis apparatus 100 according to Embodiment 1.

FIG. 12 is a diagram for explaining the processing of the failure diagnosis apparatus 100 according to Embodiment 1.

FIG. 13 is a diagram illustrating a hardware configuration example of the failure diagnosis apparatus 100 according to a modification of Embodiment 1.

FIG. 14 is a diagram illustrating a configuration example of the failure diagnosis system 90 according to Embodiment 2.

FIG. 15 is a flowchart illustrating the operation of the failure diagnosis apparatus 100 according to Embodiment 2.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in the drawings mainly indicate flows of data or flows of processing. Further, “unit” may be suitably interpreted as “circuit”, “step”, “procedure”, “process”, or “circuitry”.

### Embodiment 1

The present embodiment will be described below in detail with reference to the drawings.

### Description of Configuration

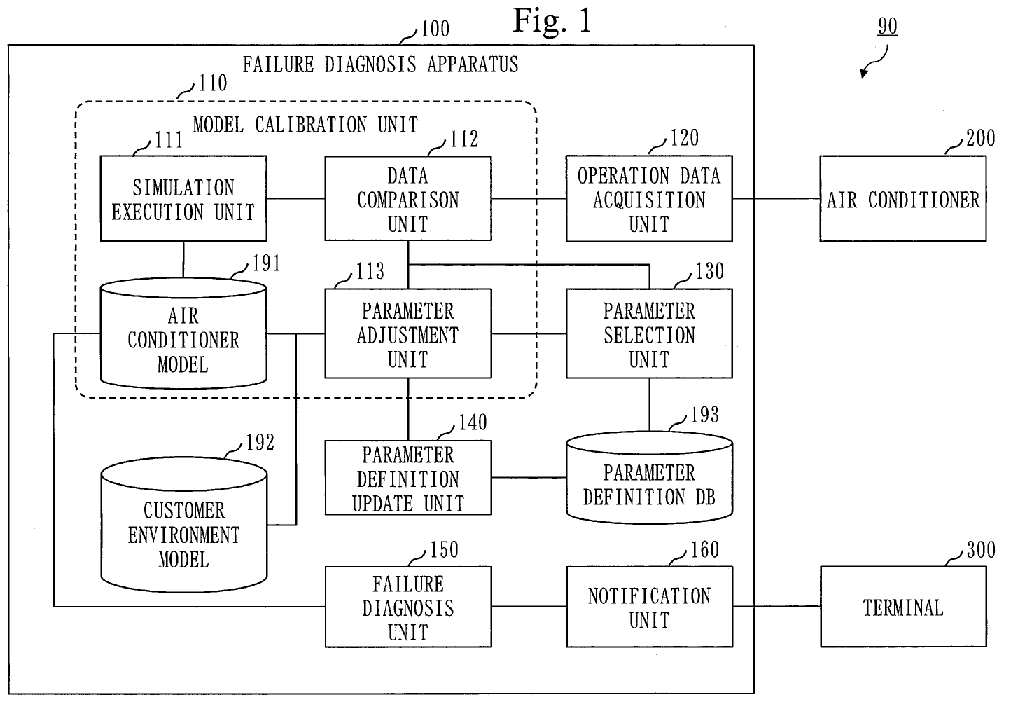

FIG. 1 illustrates a configuration example of a failure diagnosis system 90 according to the present embodiment. As illustrated in FIG. 1, the failure diagnosis system 90 includes a failure diagnosis apparatus 100, an air conditioner 200, and a terminal 300.

The failure diagnosis apparatus 100 includes a model calibration unit 110, an operation data acquisition unit 120, a parameter selection unit 130, a parameter definition update unit 140, a failure diagnosis unit 150, and a notification unit 160. Further, the failure diagnosis apparatus 100 stores an air conditioner model 191, a customer environment model 192, and a parameter definition database (DB) 193. The failure diagnosis apparatus 100 calibrates the air conditioner model 191 by adjusting a value of a parameter of the air conditioner model 191.

The model calibration unit 110 includes a simulation execution unit 111, a data comparison unit 112, a parameter adjustment unit 113, and the air conditioner model 191. The model calibration unit 110 calibrates the air conditioner model 191 to conform to the actual air conditioner 200 corresponding to the air conditioner model 191, by repeating a simulation and the adjustment of the parameter of the air conditioner model 191 until an estimation value of the parameter of the air conditioner model 191 converges.

The simulation execution unit 111 executes the simulation of operation of the air conditioner 200, using a simulator and the air conditioner model 191. The simulator is a tool that executes the simulation of the operation of the air conditioner 200, using the air conditioner model 191.

The data comparison unit 112 compares operation data generated by the simulation execution unit 111 with operation data acquired by the operation data acquisition unit 120.

In a case where a state of the air conditioner 200 is a state in which the air conditioner 200 is assumed to have a failure, the parameter adjustment unit 113 may use a parameter value indicated in the customer environment model 192, as an initial value at a time of the calibration of the air conditioner model 191. A specific example of the state in which the air conditioner 200 is assumed to have the failure is an abnormal state.

The operation data acquisition unit 120 acquires from the air conditioner 200, the operation data of the air conditioner 200. The operation data acquisition unit 120 may acquire the operation data locally using a wire or wirelessly, or may acquire the operation data remotely through the Internet or the like.

The parameter selection unit 130 refers to the parameter definition DB 193 to select a parameter of the air conditioner model 191, as an adjustment subject, based on a condition according to the state of the air conditioner 200. That is, the parameter selection unit 130 refers to the parameter definition DB 193 to select from among parameters of the air conditioner model 191, each parameter that forms an adjustment parameter group, based on the condition according to the state of the air conditioner 200. The adjustment parameter group includes at least one parameter whose value is a candidate to be adjusted when the air conditioner model 191 is calibrated. A specific example of the condition according to the state of the air conditioner 200 is a normal state or the abnormal state. A specific example of the normal state is a time when the air conditioner 200 operates normally and the calibration of the air conditioner model 191 converges normally. The abnormal state is a time other than the normal state, and a specific example of the abnormal state is a time when the calibration of the air conditioner model 191 does not converge normally or is a time when an abnormality is reported from the air conditioner 200.

Further, when a difference between the operation data of the air conditioner 200 indicated in a result of executing the calibrated simulation and the actual operation data of the air conditioner 200 corresponding to the calibrated simulation is equal to or greater than a threshold value, the parameter selection unit 130 selects each parameter that forms an additional parameter group, from parameters other than the parameter that forms the adjustment parameter group among the parameters of the air conditioner model 191, and adds to the adjustment parameter group, each parameter that forms the additional parameter group. Here, the calibrated simulation is the simulation of the operation of the air conditioner 200, using the air conditioner model 191 calibrated by adjusting a value of each parameter that forms the adjustment parameter group. The additional parameter group includes at least one parameter whose value is a candidate to be adjusted when the air conditioner model 191 is calibrated. The actual operation data of the air conditioner 200 corresponding to the calibrated simulation is operation data generated by the air conditioner 200 which is a simulation subject in the calibrated simulation.

When a value of any parameter that forms the additional parameter group has been adjusted, the parameter definition update unit 140 adds to the parameter definition DB 193, each parameter whose value has been adjusted and that forms the additional parameter group, as an adjustment parameter corresponding to a condition corresponding to the calibrated simulation.

The failure diagnosis unit 150 diagnoses the failure in the air conditioner 200, based on a result of calibrating the air conditioner model 191.

The notification unit 160 notifies the terminal 300 of a result of diagnosing the failure in the air conditioner 200 by the failure diagnosis unit 150.

The air conditioner model 191 is a mathematical model that assumes an operation environment of the air conditioner 200, and is a mathematical model used when the simulation of the operation of the air conditioner 200 is executed.

The customer environment model 192 is the air conditioner model 191 corresponding to the air conditioner 200 owed by a customer. The failure diagnosis apparatus 100 holds the calibrated air conditioner model 191 as the customer environment model 192. The failure diagnosis apparatus 100 may prepare the customer environment model 192 for each customer. The customer environment model 192 may be the air conditioner model 191 calibrated in a case where the state of the air conditioner 200 is a state in which the air conditioner 200 is assumed to have no failure. A specific example of the state in which the air conditioner 200 is assumed to have no failure is the normal state.

The parameter definition DB 193 is a database that records at least one adjustment parameter. The adjustment parameter is a parameter corresponding to each condition according to the state of the air conditioner 200, is a parameter of the air conditioner model 191, and is a parameter which is a candidate to be adjusted when the air conditioner model 191 is calibrated. The parameter definition DB 193 may record information indicating a possible range of a value of each adjustment parameter.

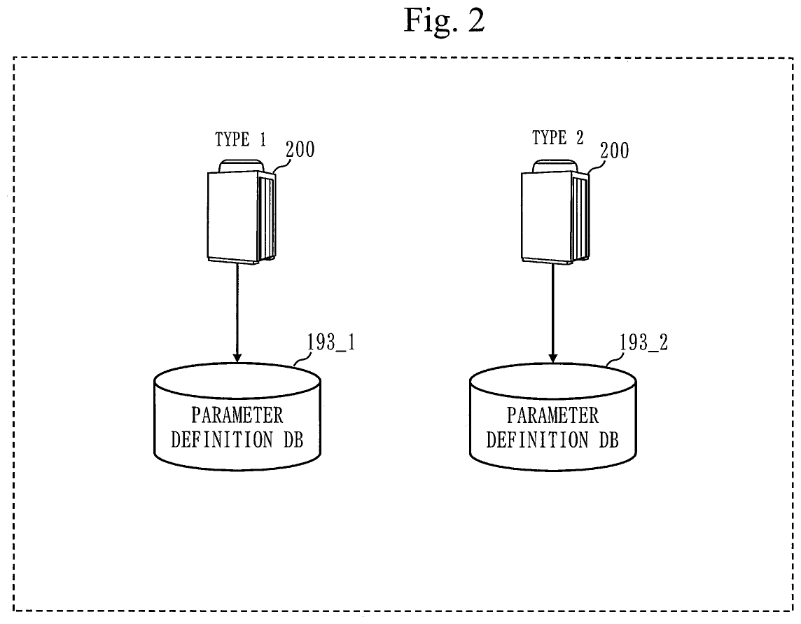

As illustrated in FIG. 2, the parameter definition DB 193 may be prepared for each type of the air conditioner 200 or for each condition such as a customer environment. Specific examples of the customer environment include a location of a building and a climate at the location. A parameter definition DB 193_1 corresponding to a type 1 and a parameter definition DB 193_2 corresponding to a type 2 are prepared in FIG. 2. When a plurality of parameter definition DBs 193 are prepared, the parameter selection unit 130 and the parameter definition update unit 140 suitably select the parameter definition DB 193 according to a condition.

Specific examples of a parameter which is possible to be the adjustment subject during the calibration of the air conditioner model 191 include a parameter of each component used for the air conditioner 200 and a relation parameter other than the air conditioner 200. Specific examples of a parameter of each of components used for the air conditioner 200 include a parameter of an accumulator, a parameter of a heat exchanger, a parameter indicating performance of a compressor, a parameter indicating a thermal conductivity, a parameter indicating an evaporation temperature, a parameter indicating a condensation temperature, a parameter indicating a pipe length, a parameter indicating a type of a refrigerant, a parameter indicating a property of a refrigerant, and a parameter indicating an enclosing refrigerant amount. Specific examples of information that is not possible to be the adjustment subject during the calibration of the air conditioner model 191 include information indicating a control sequence of the air conditioner 200 and information indicating a connection relation between each of the components. Specific examples of the information indicating the connection relation between each of the components include information indicating the connection relation between an outdoor unit, an indoor unit, and a pipe, information indicating the connection relation between an accumulator, a heat exchanger, a compressor, a valve, and the like, in the outdoor unit, and information indicating the connection relation between a heat exchanger and a valve in the indoor unit.

The air conditioner 200 communicates with the failure diagnosis apparatus 100. The air conditioner 200 is typically owned by a customer.

The terminal 300 is a device that communicates with the failure diagnosis apparatus 100, and a specific example of the terminal 300 is a Personal Computer (PC) or a tablet terminal.

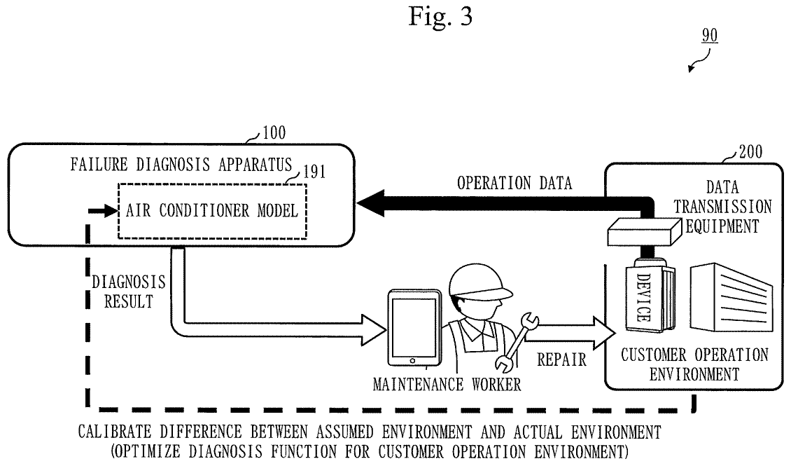

FIG. 3 is a diagram for explaining an outline of the failure diagnosis system 90.

The air conditioner 200 includes data transmission equipment. Here, the customer operation environment is an environment in which the air conditioner 200 operates. The actual environment is an environment in which the air conditioner 200 actually operates. In the customer operation environment, unknown factors are factors such as a pipe length connected to the outdoor unit, a size of a room, and an outdoor air temperature. Since these unknown factors may affect a failure diagnosis of the air conditioner 200, the failure diagnosis apparatus 100 calibrates the air conditioner model 191.

The failure diagnosis apparatus 100 refers to the operation data of the air conditioner 200 to calibrate the air conditioner model 191.

Further, when a failure occurs in the air conditioner 200, the failure diagnosis apparatus 100 diagnoses the failure in the air conditioner 200, using the calibrated air conditioner model 191, and notifies the terminal 300 owned by a maintenance worker of information indicating a result of the diagnosis. The maintenance worker repairs the air conditioner 200 based on the information notified by the terminal 300.

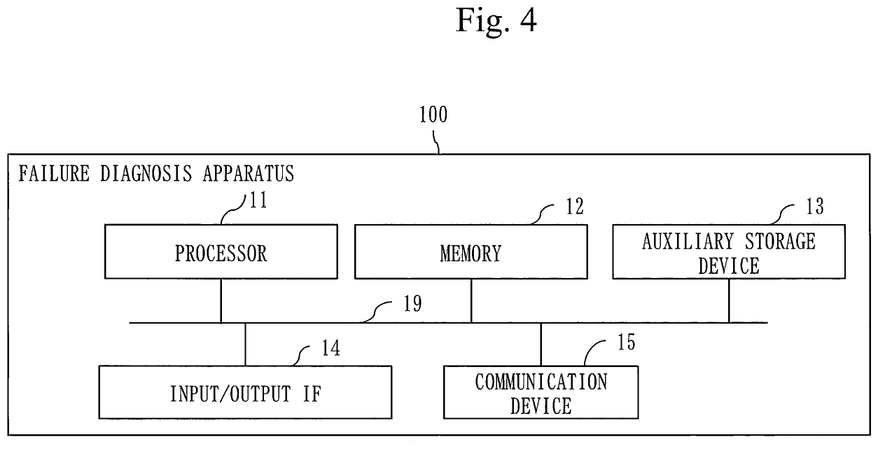

FIG. 4 illustrates a hardware configuration example of the failure diagnosis apparatus 100 according to the present embodiment. The failure diagnosis apparatus 100 includes a computer. The failure diagnosis apparatus 100 may include a plurality of computers.

As illustrated in the present diagram, the failure diagnosis apparatus 100 is the computer that includes pieces of hardware such as a processor 11, a memory 12, an auxiliary storage device 13, an input/output Interface (IF) 14, and a communication device 15. These pieces of hardware are suitably connected via signal lines 19.

The processor 11 is an Integrated Circuit (IC) that performs arithmetic processing and controls the hardware included in the computer. A specific example of the processor 11 is a Central Processing Unit (CPU), a Digital Signal Processor (DSP), or a Graphics Processing Unit (GPU).

The failure diagnosis apparatus 100 may include a plurality of processors in place of the processor 11. The plurality of processors share the role of the processor 11.

The memory 12 is typically a volatile storage device. The memory 12 is also referred to as a main storage device or a main memory. A specific example of the memory 12 is a Random Access Memory (RAM). Data stored in the memory 12 is saved in the auxiliary storage device 13 as necessary.

The auxiliary storage device 13 is typically a non-volatile storage device. A specific example of the auxiliary storage device 13 is a Read Only Memory (ROM), a Hard Disk Drive (HDD), or a flash memory. Data stored in the auxiliary storage device 13 is loaded into the memory 12 as necessary.

The memory 12 and the auxiliary storage device 13 may be configured integrally.

The input/output IF 14 is a port to which an input device and an output device are connected. A specific example of the input/output IF 14 is a Universal Serial Bus (USB) terminal. Specific examples of the input device are a keyboard and a mouse. A specific example of the output device is a display.

The communication device 15 is a receiver and a transmitter. A specific example of the communication device 15 is a communication chip or a Network Interface Card (NIC).

When communicating with another device or the like, each of the units of the failure diagnosis apparatus 100 may suitably use the input/output IF 14 and the communication device 15.

The auxiliary storage device 13 stores a failure diagnosis program. The failure diagnosis program is a program that causes the computer to implement a function of each of the units included in the failure diagnosis apparatus 100. The failure diagnosis program is loaded into the memory 12, and executed by the processor 11. The function of each of the units included in the failure diagnosis apparatus 100 is implemented by software.

Data used when the failure diagnosis program is executed, and data and the like obtained by executing the failure diagnosis program are suitably stored in the storage device. Each of the units of the failure diagnosis apparatus 100 uses the storage device suitably. The storage device includes at least one of the memory 12, the auxiliary storage device 13, a register in the processor 11, and a cache memory in the processor 11, as an example. Note that data and information may have the same meaning. The storage device may be independent of the computer.

Functions of the memory 12 and the auxiliary storage device 13 may be implemented by another storage device.

The fault diagnosis program may be recorded in a computer readable non-volatile recording medium. A specific example of the non-volatile recording medium is an optical disc or a flash memory. The failure diagnosis program may be provided as a program product.

### ***Description of Operation***

An operation procedure of the failure diagnosis apparatus 100 is equivalent to a failure diagnosis method. Further, a program that implements operation of the failure diagnosis apparatus 100 is equivalent to the failure diagnosis program.

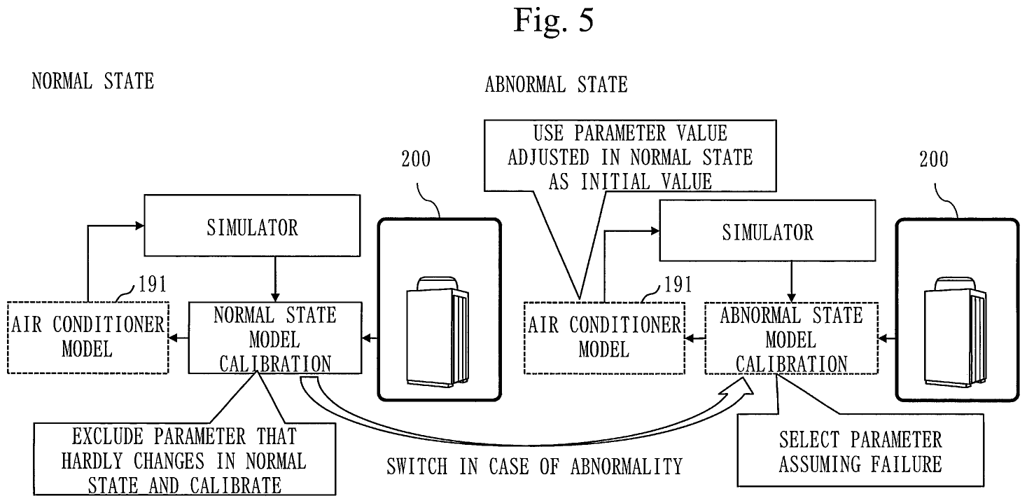

FIG. 5 is a diagram for explaining processing of the failure diagnosis apparatus 100.

In the normal state, the failure diagnosis apparatus 100 excludes from a calibration subject parameter during the model calibration, a parameter whose value hardly changes in the normal state, among the parameters of the air conditioner model 191, and calibrates the air conditioner model 191 by adjusting values of remaining parameters. In the normal state, the failure diagnosis apparatus 100 adjusts within a range that does not cause a problem, only values of unknown parameters such as a pipe length and an outdoor air temperature, and a value of a parameter including an error of such as a refrigerant amount, as a specific example.

In the abnormal state, first, the failure diagnosis apparatus 100 switches a parameter whose value is to be adjusted in the calibration of the air conditioner model 191. The parameter whose value is to be adjusted in the abnormal state is a parameter selected based on the assumption of the failure in the air conditioner 200. After that, the failure diagnosis apparatus 100 calibrates the air conditioner model 191, using a parameter value indicated in the air conditioner model 191 calibrated in the normal state, as the initial value. It is expected that the calibration of the air conditioner model 191 converges more quickly, by using the parameter value indicated in the air conditioner model 191 calibrated in the normal state, as the initial value.

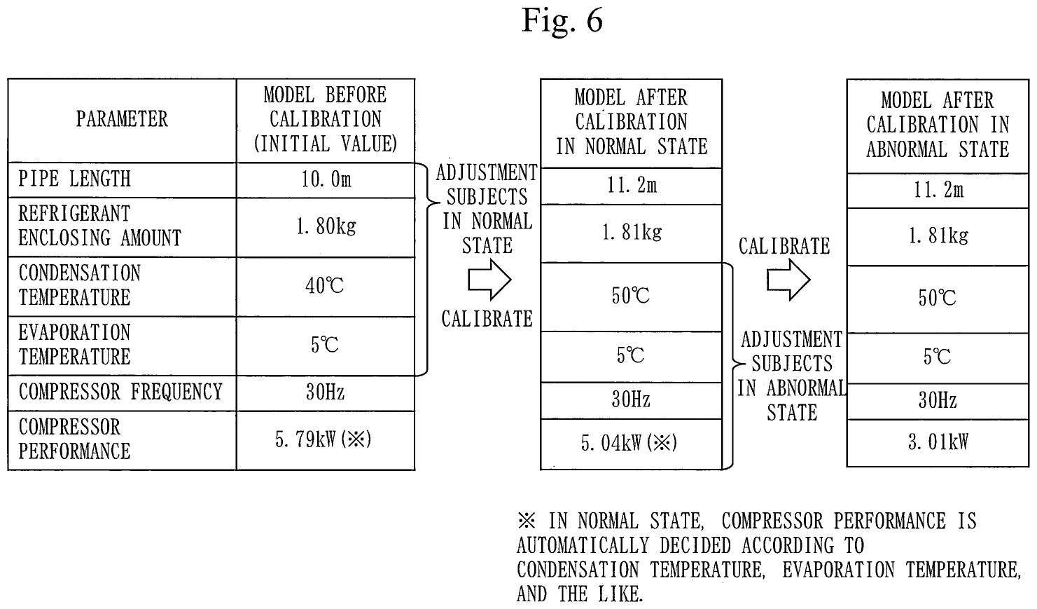

FIG. 6 is a diagram for explaining the processing of the failure diagnosis apparatus 100 with reference to a specific example.

In the normal state, the failure diagnosis apparatus 100 calibrates the air conditioner model 191 by adjusting each of the values of the parameters which are the adjustment subjects in the normal state, using the parameter values indicated in the air conditioner model 191 before the calibration, as the initial values. In the present example, the parameter adjustment unit 113 does not directly adjust the value of “compressor performance” in the normal state, but automatically decides the value of “compressor performance” according to “condensation temperature”, “evaporation temperature”, and the like.

In the abnormal state, the failure diagnosis apparatus 100 calibrates the air conditioner model 191 by adjusting each of the values of the parameters which are the adjustment subjects in the abnormal state, using the parameter values indicated in the air conditioner model 191 before the calibration, as the initial values.

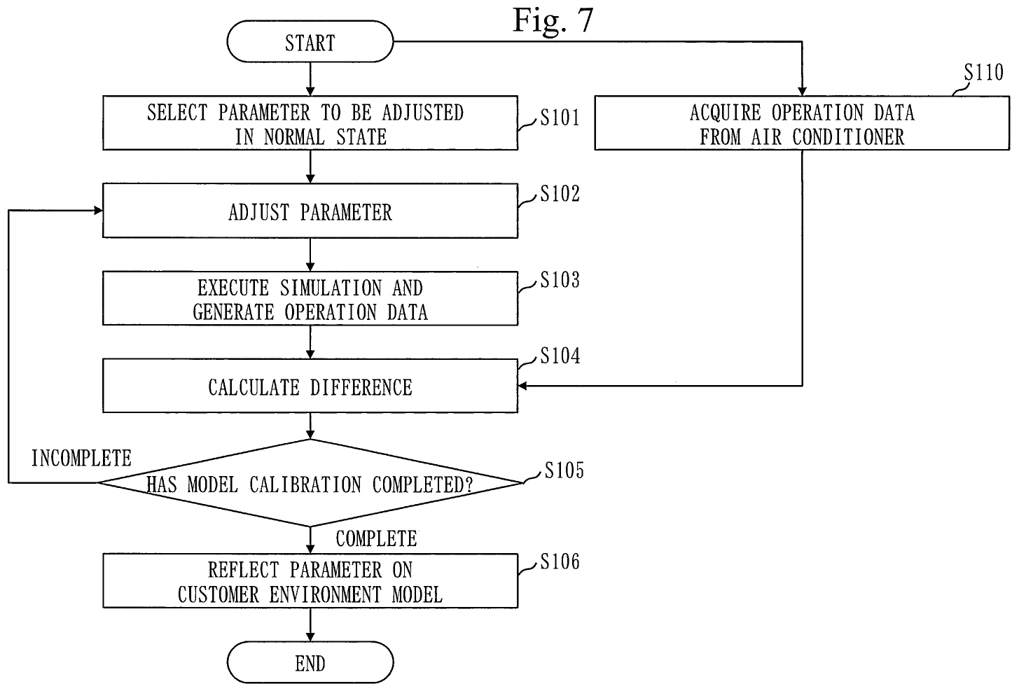

FIG. 7 is a flowchart illustrating an example of the operation of the failure diagnosis apparatus 100 in the normal state. The operation of the failure diagnosis apparatus 100 in the normal state will be described with reference to FIG. 7.

### (Step S101)

The parameter selection unit 130 refers to the parameter definition DB 193 to select a parameter whose value is to be adjusted in the normal state. Each parameter selected in the present step corresponds to a parameter that forms the adjustment parameter group.

### (Step S102)

The parameter adjustment unit 113 suitably adjusts the value of the parameter selected by the parameter selection unit 130 among the parameters of the air conditioner model 191. At this time, the parameter adjustment unit 113 may adjust the value of the parameter based on any optimization method. The parameter adjustment unit 113 may adjust only values of some parameters among the parameters selected by the parameter selection unit 130.

When executing the present step for the first time, the parameter adjustment unit 113 reads the air conditioner model 191, sets a parameter value indicated in the read air conditioner model 191 as the initial value, and suitably adjusts the initial value. Otherwise, the parameter adjustment unit 113 further suitably adjusts a value of a parameter that has been adjusted when the present step has been previously executed.

### (Step S103)

The simulation execution unit 111 generates the operation data of the air conditioner 200 by executing the simulation of the operation of the air conditioner 200, using the simulator and the air conditioner model 191 whose parameter value has been adjusted by the parameter adjustment unit 113.

### (Step S104)

The data comparison unit 112 calculates a difference between the operation data generated by the simulation execution unit 111 and the operation data acquired by the operation data acquisition unit 120. The data comparison unit 112 may calculate the difference between these pieces of operation data in any manner.

### (Step S105)

When the calibration of the air conditioner model 191 has completed, the model calibration unit 110 proceeds to step S106. Otherwise, the model calibration unit 110 proceeds to step S102.

The model calibration unit 110 may determine whether or not the calibration of the air conditioner model 191 has completed by determining whether or not the difference calculated by the data comparison unit 112 is less than or equal to a threshold value, or by determining whether or not the number of execution of repetitive processes from step S102 to step S104 has reached a predetermined value.

### (Step S106)

The parameter adjustment unit 113 reflects a result of calibrating the air conditioner model 191 on the customer environment model 192. Specifically, the parameter adjustment unit 113 saves in the customer environment model 192, the value of the parameter adjusted when the air conditioner model 191 is calibrated.

### (Step S110)

The operation data acquisition unit 120 acquires from the air conditioner 200, the operation data of the air conditioner 200.

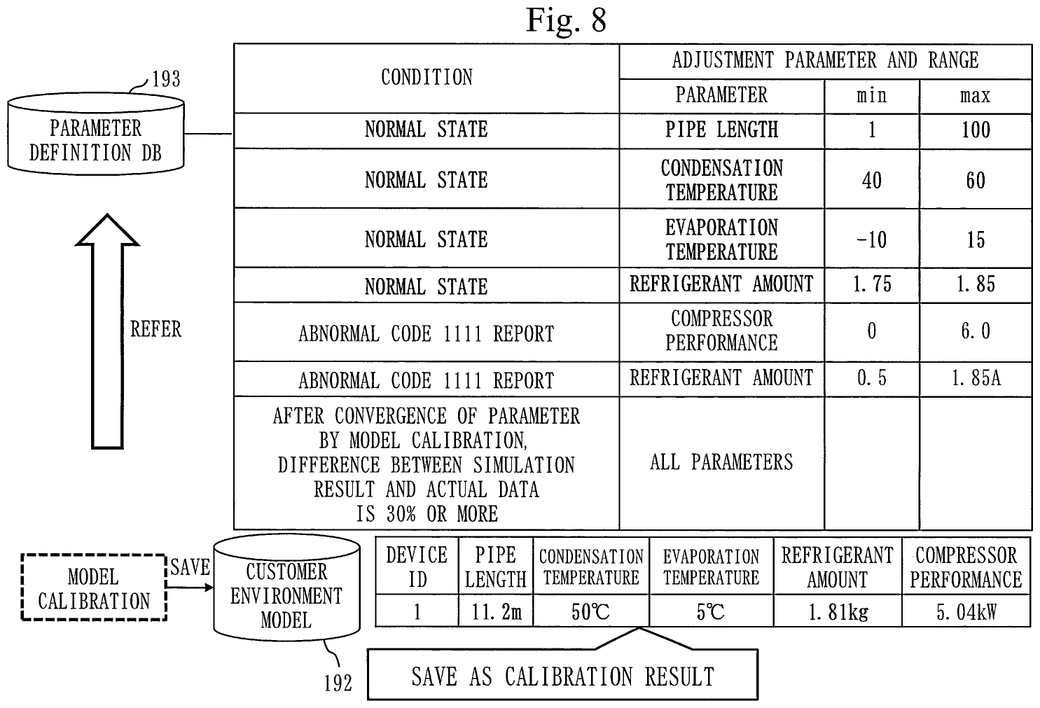

FIG. 8 is a diagram for explaining the processing of the failure diagnosis apparatus 100 in the normal state with reference to a specific example. In the present example, the parameter definition DB 193 indicates each of “pipe length”, “condensation temperature”, “evaporation temperature”, and “refrigerant amount”, as parameters to be adjusted in the normal state.

Accordingly, the parameter adjustment unit 113 adjusts each of values of “pipe length”, “condensation temperature”, “evaporation temperature” and “refrigerant amount”, in the calibration of the air conditioner model 191. Further, the parameter adjustment unit 113 saves in the customer environment model 192, each of the adjusted values of “pipe length”, “condensation temperature”, “evaporation temperature”, and “refrigerant amount”, as a calibration result.

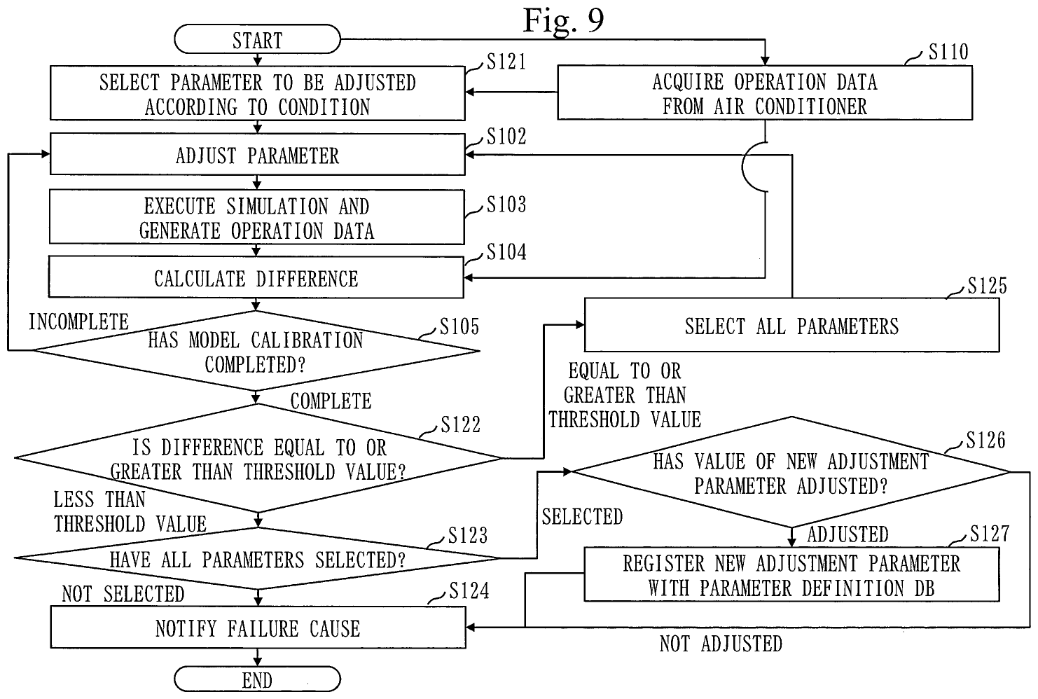

FIG. 9 is a flowchart illustrating an example of the operation of the failure diagnosis apparatus 100 in a diagnosis state. The operation of the failure diagnosis apparatus 100 in the diagnosis state will be described with reference to FIG. 9. The diagnosis state is one mode of the abnormal state, and is a time when the air conditioner 200 is necessary to be diagnosed.

### (Step S121)

The parameter selection unit 130 refers to the parameter definition DB 193 to select a parameter to be adjusted in the diagnosis state, based on the condition according to the state of the air conditioner 200. Each parameter selected in the present step corresponds to a parameter that forms the adjustment parameter group.

### (Step S122)

The data comparison unit 112 calculates a difference between the operation data corresponding to the calibrated air conditioner model 191 and the operation data acquired by the operation data acquisition unit 120.

When the calculated difference is equal to or greater than a threshold value, the failure diagnosis apparatus 100 proceeds to step S125. Otherwise, the failure diagnosis apparatus 100 proceeds to step S123.

### (Step S123)

When all of the parameters of the air conditioner model 191 has been selected as parameters whose values are to be adjusted, the failure diagnosis apparatus 100 proceeds to step S126. Otherwise, the failure diagnosis apparatus 100 proceeds to step S124.

### (Step S124)

The failure diagnosis unit 150 diagnoses a failure in the air conditioner 200, using the air conditioner model 191.

The notification unit 160 transmits to the terminal 300, data indicating a result of the diagnosis by the failure diagnosis unit 150.

### (Step S125)

The parameter selection unit 130 refers to the parameter definition DB 193 to select all parameters whose values are possible to be adjusted, from among the parameters of the air conditioner model 191. The parameter selection unit 130 may not select some parameters from among all the parameters.

A parameter that is not included in the adjustment parameter group, among the parameters selected in the present step corresponds to a parameter that forms the additional parameter group. That is, the process of the present step is equivalent to a process of adding to the adjustment parameter group, each parameter that forms the additional parameter group.

### (Step S126)

When each of values of new adjustment parameters has been adjusted by the parameter adjustment unit 113, the failure diagnosis apparatus 100 proceeds to step S127. Here, the new adjustment parameters are parameters other than a parameter indicated in the parameter definition DB 193 as a parameter to be adjusted at a time when the condition according to the state of the air conditioner 200 is the condition in step S121. Further, the new adjustment parameters are included in the additional parameter group. Otherwise, the failure diagnosis apparatus 100 proceeds to step S124.

### (Step S127)

The parameter definition update unit 140 registers with the parameter definition DB 193, each of the new adjustment parameters, as the parameter to be adjusted at a time when the condition according to the state of the air conditioner 200 is the condition in step S121.

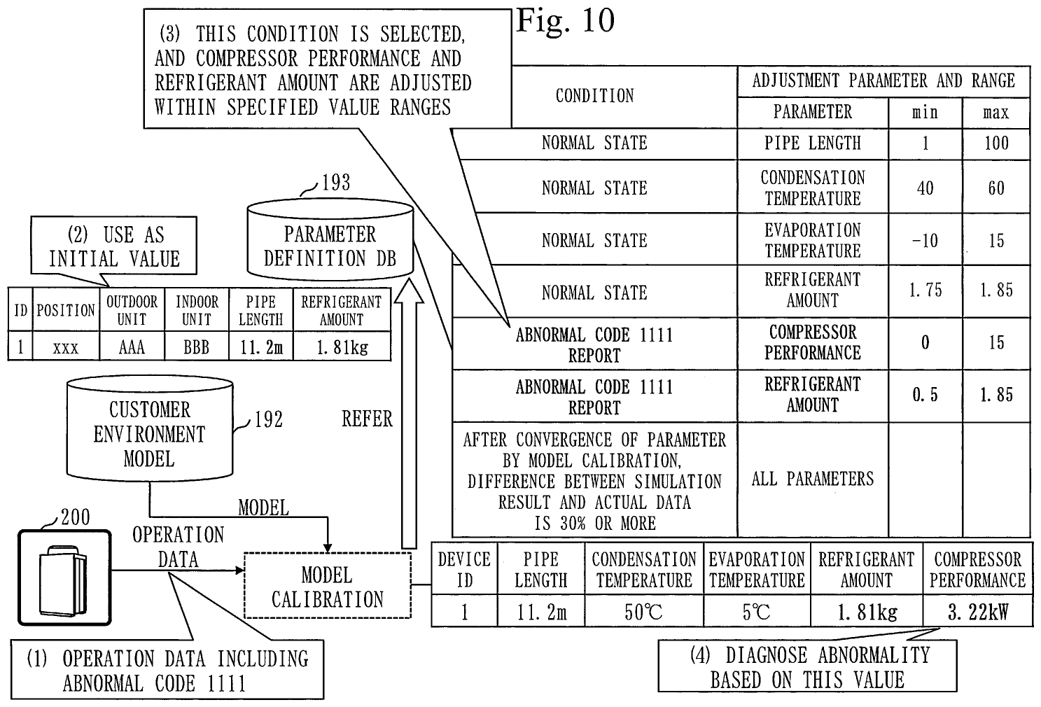

FIG. 10 is a diagram for explaining the processing of the failure diagnosis apparatus 100 in the diagnosis state with reference to a specific example. The processes in the present example will be described in order.

First, the air conditioner 200 transmits to the failure diagnosis apparatus 100, operation data including “abnormal code 1111”. “Abnormal code 1111” is a specific example of data indicating that the air conditioner 200 has an abnormality.

Next, since the air conditioner 200 has transmitted “abnormal code 1111”, the parameter selection unit 130 refers to the parameter definition DB 193 to select “compressor performance” and “refrigerant amount” which are parameters corresponding to “abnormal code 1111 report”. Here, “abnormal code 1111 report” is an example in the diagnosis state.

Next, the model calibration unit 110 calibrates the air conditioner model 191 by adjusting each of values of “compressor performance” and “refrigerant amount” within each of ranges of “compressor performance” and “refrigerant amount” indicated in the parameter definition DB 193, using parameter values indicated in the air conditioner model 191 calibrated in the normal state, as the initial values. The initial values are saved in the customer environment model 192, as a specific example. Further, the parameter adjustment unit 113 saves in the customer environment model 192, the parameter values indicated in the calibrated air conditioner model 191.

Next, the failure diagnosis unit 150 diagnoses an abnormality in the air conditioner 200, based on the value of “compressor performance” indicated in the air conditioner model 191 calibrated by the model calibration unit 110.

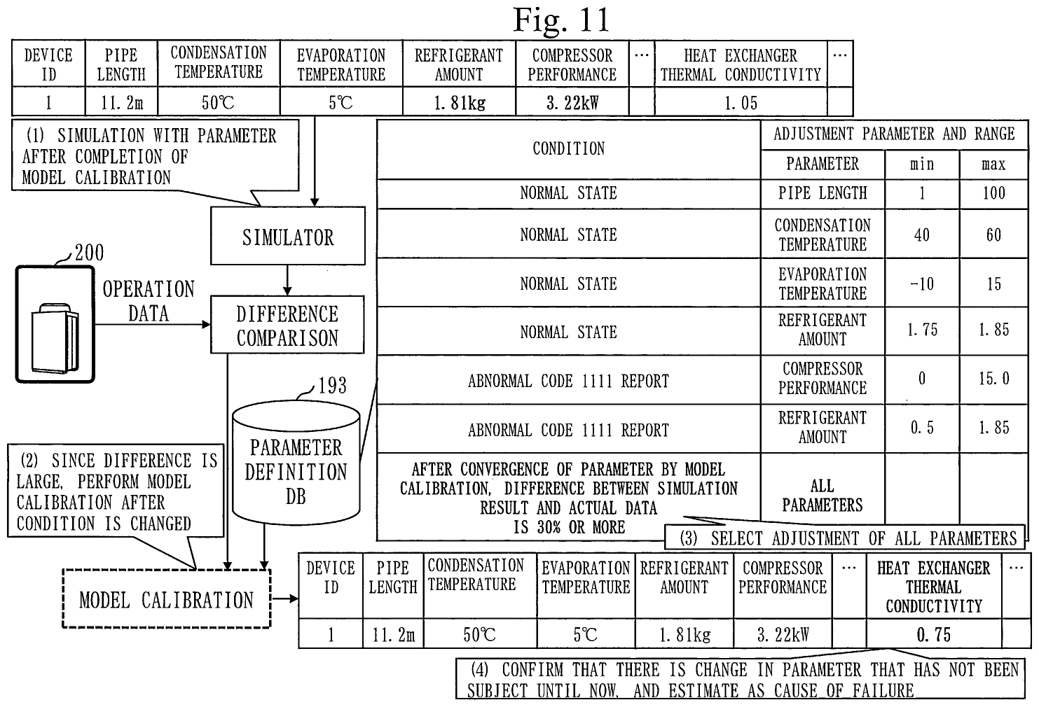

FIG. 11 is a diagram for explaining the processing of the failure diagnosis apparatus 100 in the diagnosis state with reference to a specific example. The present example corresponds to processing that follows the specific example illustrated in FIG. 10. The processing in the present example will be described in order.

First, the simulation execution unit 111 generates a “simulation result” which is operation data by executing the simulation of the operation of the air conditioner 200, using the calibrated air conditioner model 191.

Next, the data comparison unit 112 calculates a difference between “actual data” and the “simulation result”. At this time, it is assumed that the size of the calculated difference is 30% or more of the size of the “actual data”. Here, the “actual data” is operation data acquired by the operation data acquisition unit 120 from the air conditioner 200. Further, a specific example of the size of the “actual data” is a norm of a vector corresponding to the “actual data”. Each of the size of the “simulation result” and the size of the difference is the same as the size of the “actual data”.

Next, since the difference between the “actual data” and the “simulation result” is equal to or greater than a threshold value, the parameter selection unit 130 selects all of the parameters of the air conditioner model 191, as parameters that form the adjustment parameter group.

Next, the model calibration unit 110 calibrates the air conditioner model 191 by adjusting the values of all of the parameters.

Next, the failure diagnosis unit 150 confirms that the value of “heat exchanger thermal conductivity” in the calibrated air conditioner model 191 has changed from before the calibration, and estimates that a cause of a failure of the air conditioner 200 relates to “heat exchanger thermal conductivity”.

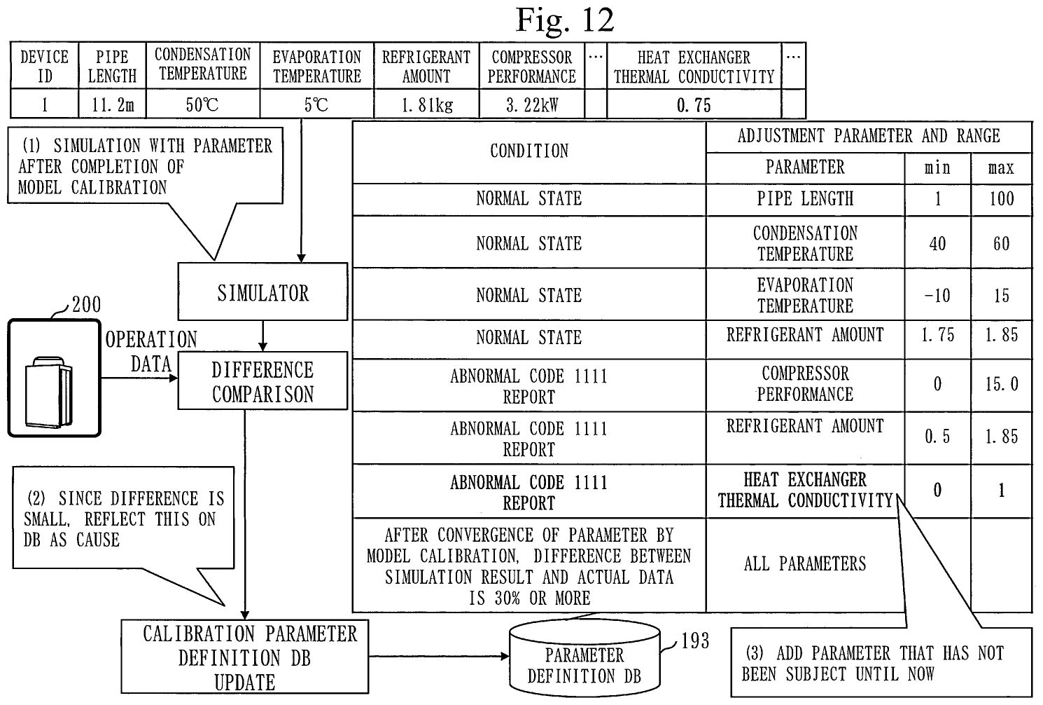

FIG. 12 is a diagram for explaining the processing of the failure diagnosis apparatus 100 in the diagnosis state with reference to a specific example. The preset example corresponds to processing that follows the specific example illustrated in FIG. 11. The processing in the present example will be given in order.

First, the model calibration unit 110 generates the “simulation result” by executing the simulation of the operation of the air conditioner 200, using the calibrated air conditioner model 191. After that, the data comparison unit 112 calculates the difference between the “actual data” and the “simulation result”. Here, the calculated difference is assumed to be less than the threshold value.

Next, the parameter definition update unit 140 determines that the reason for the difference between the “actual data” and the “simulation result” being equal to or greater than the threshold value is the value of “heat exchanger thermal conductivity” has not been adjusted since the difference between the “actual data” and the “simulation result” is less than the threshold value by newly adjusting the value of “heat exchanger thermal conductivity”. Accordingly, the parameter definition update unit 140 reflects a result of adjusting the value of “heat exchanger thermal conductivity” on the parameter definition DB 193.

As a result, as illustrated in FIG. 12, “heat exchanger thermal conductivity” is added to the parameter definition DB 193, as a parameter to be adjusted in a case where the condition is “abnormal code 1111 report”.

### Description of Effects of Embodiment 1

As described above, according to the present embodiment, since only values of some of parameters of the air conditioner model 191 are to be adjusted when the air conditioner model 191 is calibrated particularly in a normal state, a time required for calibration of the air conditioner model 191 can be shortened. Further, according to the present embodiment, it is possible to correct a factor that is influenced by a customer environment in a simulation of operation of the air conditioner 200, and at the same time, specify a failure cause of the air conditioner 200, and to provide the specified failure cause to a maintenance worker.

### ***Other Configurations***

### <Modification 1>

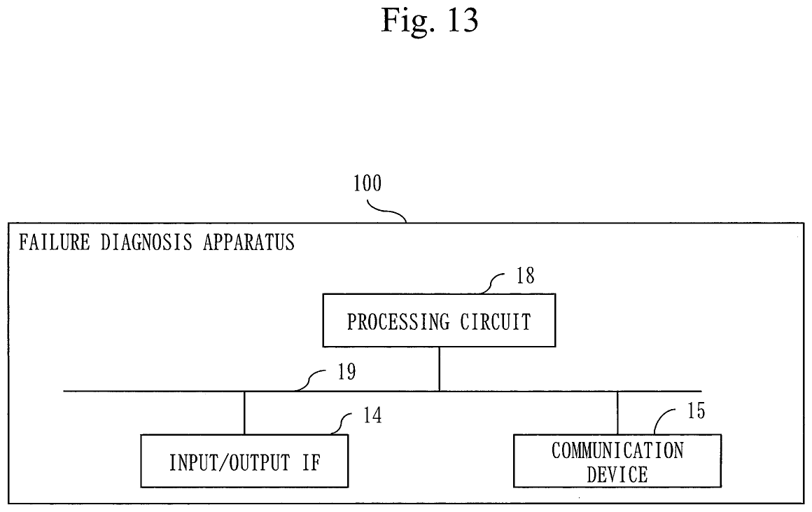

FIG. 13 illustrates a hardware configuration example of the failure diagnosis apparatus 100 according to the present modification.

The failure diagnosis apparatus 100 includes a processing circuit 18 in place of the processor 11, the processor 11 and the memory 12, the processor 11 and the auxiliary storage device 13, or the processor 11, the memory 12, and the auxiliary storage device 13.

The processing circuit 18 is hardware that implements at least a part of each unit included in the failure diagnosis apparatus 100.

The processing circuit 18 may be a dedicated hardware, or may be a processor that executes programs stored in the memory 12.

When the processing circuit 18 is the dedicated hardware, a specific example of the processing circuit 18 is a single circuit, a composite circuit, a programmed processor, a parallel-programmed processor, an Application Specific Integrated Circuit (ASIC), a Field Programmable Gate Array (FPGA), or a combination of thereof.

The failure diagnosis apparatus 100 may include a plurality of processing circuits as an alternative to the processing circuit 18. The plurality of processing circuits share the role of the processing circuit 18.

In the failure diagnosis apparatus 100, some functions may be implemented by dedicated hardware, and the remaining functions may be implemented by software or firmware.

The processing circuit 18 is implemented by, as a specific example, hardware, software, firmware, or a combination of thereof.

The processor 11, the memory 12, the auxiliary storage device 13, and the processing circuit 18 are collectively referred to as “processing circuitry”. That is, the functions of the individual functional components of the failure diagnosis apparatus 100 are implemented by the processing circuitry.

The failure diagnosis apparatus 100 according to other embodiments may also have the same configuration as that of the present modification.

### Embodiment 2

Differences from the above described embodiment will be mainly described below with reference to the drawings.

### ***Description of Configuration***

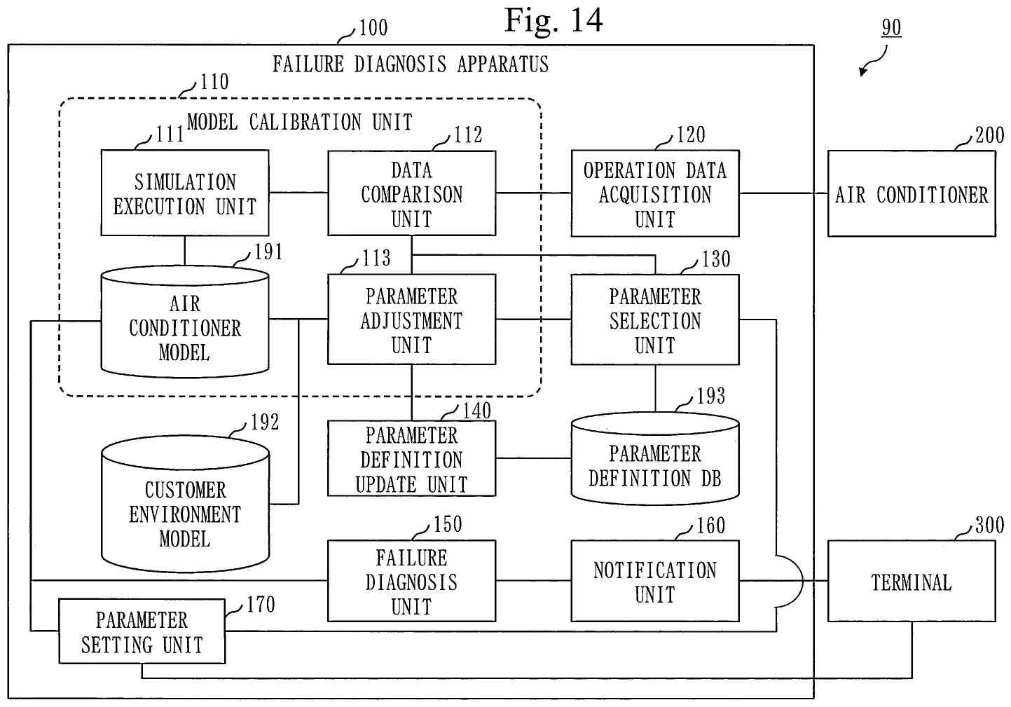

FIG. 14 illustrates a configuration example of the failure diagnosis system 90 according to the present embodiment.

As illustrated in FIG. 14, the failure diagnosis apparatus 100 includes a parameter setting unit 170 in addition to the components included in the failure diagnosis apparatus 100 according to Embodiment 1.

The parameter setting unit 170 sets a value of at least one parameter of the air conditioner model 191. The parameter setting unit 170 may receive a value set by a maintenance worker or the like, or data indicating a parameter file or the like, and may set each of the parameters of the air conditioner model 191 according to the received data.

The calibration of the air conditioner model 191 can be converged more quickly by the maintenance worker or the like setting actual values in the air conditioner 200, as values of some parameters among the parameters of the air conditioner model 191. The maintenance worker or the like may set a value that can be read from a specification or a value that can be measured in an actual environment.

The parameter selection unit 130 according to the present embodiment excludes from the adjustment parameter group, each parameter whose value has been set by the parameter setting unit 170.

### ***Description of Operation***

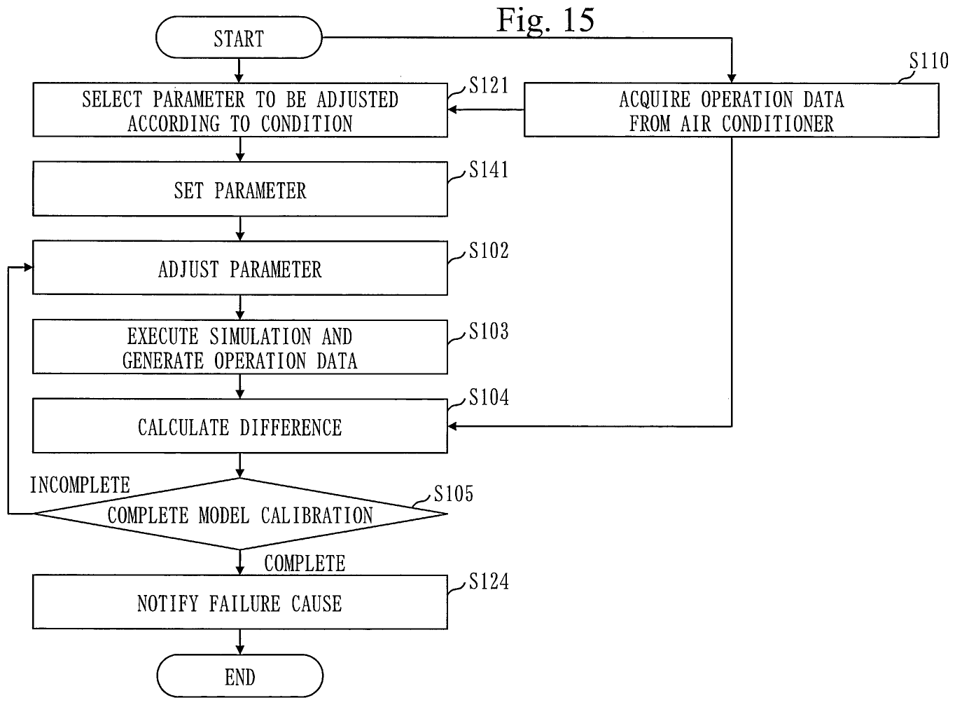

FIG. 15 is a flowchart illustrating an example of the operation of the failure diagnosis apparatus 100. The operation of the failure diagnosis apparatus 100 will be described with reference to FIG. 15.

### (Step S141)

The parameter setting unit 170 receives data indicating a parameter value to be set in the air conditioner model 191, and sets a value of a parameter of the air conditioner model 191 according to the received data. The parameter whose value is to be set by the parameter setting unit 170 may not be a parameter selected by the parameter selection unit 130.

The parameter selection unit 130 excludes from the adjustment parameter group, each parameter whose value has been set by the parameter setting unit 170.

### Description of Effects of Embodiment 2

As described above, according to the present embodiment, a value of a parameter of the air conditioner model 191 can be set. Further, when a parameter value in an actual environment has been set in the air conditioner model 191, a time required for calibration of the air conditioner model 191 can be further shortened.

### Other Embodiments

Each of the above described embodiments can be freely combined, or any component of each of the embodiments can be modified. Alternatively, any component can be omitted in each of the embodiments.

Alternatively, the embodiments are not limited to those presented in Embodiments 1 and 2, and various modifications can be made as needed. The procedures described using the flowcharts or the like may be suitably modified.

### REFERENCE SIGNS LIST

11: processor; 12: memory; 13: auxiliary storage device; 14: input/output IF; 15: communication device; 18: processing circuit; 19: signal line; 90: failure diagnosis system; 100: failure diagnosis apparatus; 110: model calibration unit; 111: simulation execution unit; 112: data comparison unit; 113: parameter adjustment unit; 120: operation data acquisition unit; 130: parameter selection unit; 140: parameter definition update unit; 150: failure diagnosis unit; 160: notification unit; 170: parameter setting unit; 191: air conditioner model; 192: customer environment model; 193: parameter definition DB; 200: air conditioner; 300: terminal.

1. A failure diagnosis apparatus that calibrates an air conditioner model by adjusting a value of a parameter of the air conditioner model used when a simulation of operation of an air conditioner is executed, the failure diagnosis apparatus comprising
processing circuitry:
to select from among parameters of the air conditioner model, each parameter that forms an adjustment parameter group that consists of at least one parameter whose value is a candidate to be adjusted when the air conditioner model is calibrated based on a condition according to a state of the air conditioner, wherein
when selecting each parameter that forms the adjustment parameter group, the processing circuitry refers to a parameter definition database that records at least one adjustment parameter which is a parameter corresponding to each condition according to the state of the air conditioner and which is a parameter whose value is a candidate to be adjusted when the air conditioner model is calibrated, and
when a difference between operation data of the air conditioner indicating a result of executing the calibrated simulation which is the simulation of the operation of the air conditioner using the air conditioner model calibrated by adjusting a value of each parameter that forms the adjustment parameter group and actual operation data of the air conditioner corresponding to the calibrated simulation is equal to or greater than a threshold value, the processing circuitry selects from parameters other than a parameter that forms the adjustment parameter group among parameters of the air conditioner model, each parameter that forms an additional parameter group that consists of at least one parameter whose value is a candidate to be adjusted when the air conditioner model is calibrated, and adds to the adjustment parameter group, each parameter that forms the additional parameter group.

2. The failure diagnosis apparatus according to claim 1, wherein
when a value of any parameter that forms the additional parameter group has been adjusted, the processing circuitry adds to the parameter definition database, each parameter whose value has been adjusted and that forms the additional parameter group, as an adjustment parameter corresponding to a condition according to the calibrated simulation.

3. The failure diagnosis apparatus according to claim 1, wherein
the processing circuitry holds as a customer environment model, an air conditioner model calibrated in a case where the state of the air conditioner is a state in which the air conditioner is assumed to have no failure, and
the processing circuitry uses a parameter value indicated in the customer environment model, as an initial value when the air conditioner model is calibrated in the case where the state of the air conditioner is the state in which the air conditioner is assumed to have no failure.

4. The failure diagnosis apparatus according to claim 2, wherein
the processing circuitry holds as a customer environment model, an air conditioner model calibrated in a case where the state of the air conditioner is a state in which the air conditioner is assumed to have no failure, and
the processing circuitry uses a parameter value indicated in the customer environment model, as an initial value when the air conditioner model is calibrated in the case where the state of the air conditioner is the state in which the air conditioner is assumed to have no failure.

5. The failure diagnosis apparatus according to claim 1, wherein
the processing circuitry sets a value of at least one parameter of the air conditioner model, and
the processing circuitry excludes from the adjustment parameter group, each parameter whose value has been set.

6. The failure diagnosis apparatus according to claim 2, wherein
the processing circuitry sets a value of at least one parameter of the air conditioner model, and
the processing circuitry excludes from the adjustment parameter group, each parameter whose value has been set.

7. The failure diagnosis apparatus according to claim 3, wherein
the processing circuitry sets a value of at least one parameter of the air conditioner model, and
the processing circuitry excludes from the adjustment parameter group, each parameter whose value has been set.

8. The failure diagnosis apparatus according to claim 4, wherein
the processing circuitry sets a value of at least one parameter of the air conditioner model, and
the processing circuitry excludes from the adjustment parameter group, each parameter whose value has been set.

9. A failure diagnosis method that calibrates an air conditioner model by adjusting a value of a parameter of the air conditioner model used when a simulation of operation of an air conditioner is executed, the failure diagnosis method comprising
selecting from among parameters of the air conditioner model, each parameter that forms an adjustment parameter group that consists of at least one parameter whose value is a candidate to be adjusted when the air conditioner model is calibrated based on a condition according to a state of the air conditioner,
when selecting each parameter that forms the adjustment parameter group, referring to a parameter definition database that records at least one adjustment parameter which is a parameter corresponding to each condition according to the state of the air conditioner and which is a parameter whose value is a candidate to be adjusted when the air conditioner model is calibrated, and
when a difference between operation data of the air conditioner indicating a result of executing the calibrated simulation which is the simulation of the operation of the air conditioner using the air conditioner model calibrated by adjusting a value of each parameter that forms the adjustment parameter group and actual operation data of the air conditioner corresponding to the calibrated simulation is equal to or greater than a threshold value, selecting from parameters other than a parameter that forms the adjustment parameter group among parameters of the air conditioner model, each parameter that forms an additional parameter group that consists of at least one parameter whose value is a candidate to be adjusted when the air conditioner model is calibrated, and adding to the adjustment parameter group, each parameter that forms the additional parameter group.

10. A non-transitory computer readable medium storing a failure diagnosis program for causing a failure diagnosis apparatus which is a computer that calibrates an air conditioner model by adjusting a value of a parameter of the air conditioner model used when a simulation of operation of an air conditioner is executed, to execute
a parameter selection process to select from among parameters of the air conditioner model, each parameter that forms an adjustment parameter group that consists of at least one parameter which is a candidate to be adjusted when the air conditioner model is calibrated based on a condition according to a state of the air conditioner, wherein
when selecting each parameter that forms the adjustment parameter group, the parameter selection process refers to a parameter definition database that records at least one adjustment parameter which is a parameter corresponding to each condition according to the state of the air conditioner and which is a parameter whose value is a candidate to be adjusted when the air conditioner model is calibrated, and
when a difference between operation data of the air conditioner indicating a result of executing the calibrated simulation which is the simulation of the operation of the air conditioner using the air conditioner model calibrated by adjusting a value of each parameter that forms the adjustment parameter group and actual operation data of the air conditioner corresponding to the calibrated simulation is equal to or greater than a threshold value, the parameter selection process selects from parameters other than a parameter that forms the adjustment parameter group among parameters of the air conditioner model, each parameter that forms an additional parameter group that consists of at least one parameter whose value is a candidate to be adjusted when the air conditioner model is calibrated, and adds to the adjustment parameter group, each parameter that forms the additional parameter group.
